(19) United States
(12) Patent Application Publication
(10) Pub. No.: US 2025/0172026 A1
(43) Pub. Date: May 29, 2025

(54) POWERED HINGE FOR DOOR, SYSTEMS AND METHODS

(71) Applicant: Masonite Corporation, Tampa, FL (US)

(72) Inventors: Navid ANDALIBI-ABADAN, Chicago, IL (US); Alex BODURKA, Portage, MI (US)

(21) Appl. No.: 18/962,105

(22) Filed: Nov. 27, 2024

Related U.S. Application Data
(60) Provisional application No. 63/602,916, filed on Nov. 27, 2023.

(51) Int. Cl. E05D 11/00; E05D 7/10

(52) U.S. Cl. CPC E05D 11/0081; E05D 7/10

(57) ABSTRACT

A modular powered hinge and related system and method, are described that is configured to provide power to a modular door system.

### CROSS-REFERENCE TO RELATED APPLICATIONS

This application claims the benefit of U.S. Application No. 63/602,916, filed Nov. 27, 2023, the contents of which are incorporated by reference herein in their entirety.

### FIELD OF THE INVENTION

The present invention is related generally to doors and related systems and methods including use of powered hinges as part of the door, and more specifically to powered hinge systems that provide power for smart doors and systems.

### BACKGROUND OF THE INVENTION

Doors are an essential part of every building, providing residents with access and security. Conventional smart doors disclose fixation of devices and features within various sections of a door, many of which require a power and data source. One mechanism for delivery of power includes installation of an alternating current (AC) or direct current (DC) power line through the door frame via conduit to the door.

Another mechanism involves delivery of power by routing a channel in a hinge component and embedding a wire that extends from the frame through that routed channel in the hinge, thus creating a powered hinge component. This requires difficult machining, e.g., also including drilling a small hole through the thin side of the hinge and fishing such power and data source wires through that small hole. These custom powered hinges may also generally include multiple electronic components that may be interfaced between a jamb and a door to form the electrical connection. In some instances, it may be difficult for an operator to install such complex electronic architecture between the jamb and the hinge. In other instances, it may also be difficult for an operator to install the jamb and the hinge during house settling activities, which may need repair and re-alignment, or other events besides house settling that may require repair or realignment. Further, as there are multiple components within a minimal surface area of the jamb, it may be difficult for the operator to align the electronic components of the jamb with electronic components of the hinge. In certain instances, even after alignment, the operator may not be sure that the electrical components are electrically connected or not.

Further, there may be instances where a user or an operator of the door decides to replace or upgrade from a normal hinge to the powered hinge, e.g., during installation of a smart door or for installation of such a power channel into a smart door. In such instances, the operator may have to uninstall the normal hinge from the jamb, and then install the powered hinge in the jamb. Such process may be cumbersome and may take a substantial amount of time for the operator.

What is needed in the art is a powered hinge solution that does not require custom manufacturing as described above and that provides a rapid, facile installation for the standard operator of a smart door system.

### SUMMARY

The present disclosure overcomes the disadvantages of the art by providing a modular powered door hinge. In exemplary aspects, the powered hinge has a power plate with an array of protruding pins (such as pogo pins), complementing a powered hinge having an array of conductive pads. Alternatively, an exemplary aspect includes a power plate with an array of conductive pads and a powered hinge plate having an array of protruding pins.

In exemplary aspects, the array of pads may be coupled (for example, magnetically coupled) with the array of protruding pins, to form an electrical connection. In exemplary aspects, the location of pins and pads may also be reversed between the power plate and the powered hinge, to form the electrical connection. In exemplary aspects, there may also be oversized pads with increased surface area for optimal electrical connection and tolerance forgiveness with the pins, and vice versa.

In exemplary embodiments, the powered hinge comprises a pad side leaf and an interface side leaf, wherein the pad side leaf has the array of pads that are configured to couple with the power plate, with the interface side leaf including a status indicator (such as an LED light). The indicator may be configured to activate based on the electrical connection between all pins of the array of protruded pins and all pads of the array of pads, to ensure all contacts has been made. The indicator may also indicate various signals (such as, a yellow color indicating installation in progress, a green color indicating successful installation, and a red color indicating an abnormality in the installation). Such indicator light may also be hidden when the door is in a closed position.

In exemplary embodiments, the overall system design allows a spacer element or cover to be used to provide a non-powered hinge by covering up the power connection on the jamb (the jamb connector or the power plate) when a powered hinge is not desired, but also allowing for an easy replacement with the powered hinge when installing a smart door. In such a case, an operator can merely remove the spacer/cover of the array of pads and/or the array of protruding pins to modularly upgrade the non-powered hinge to a powered hinge. In further exemplary embodiments, there may be a push switch in the modular door hinge (in exemplary embodiments also hidden when the door is in a closed position) that performs an operation such as, resetting the modular door hinge, connecting the door to a cloud or a mobile device (such as a smartphone), troubleshooting the modular door hinge, etc.

The modular door hinge may also include other electronics (such as, PCBs, sensors, switches, etc.). Based on a validation of successful electrical connection of all pins of the array of protruded pins and all pads of the array of pads, via the indicator of the interface side leaf of the powered hinge, the interface side leaf is configured to couple with a door.

In further exemplary embodiments, power is provided through the hinge via a ribbon cable or via a flex printed circuit board (PCBA) with a cable component provided or coiled in at least a portion of the hinge itself. Such an embodiment can provide a more cost-effective solution by eliminating difficult machining and, in exemplary aspects allow for use of flexible PCBAs. Such exemplary solutions can also increase the number of electrical contacts available for a powered (or data) hinge. In exemplary aspects, a secondary molded piece can be used with the hinge to protect a ribbon cable and to house the connector and/or a PCBA.

Other aspects of the invention, including devices, systems, methods and the like which constitute part of the invention, will become more apparent upon reading the following detailed description of various exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a schematic view of an exemplary powered hinge system in accordance with exemplary aspects of the present disclosure;

FIG. 2 is a perspective view of an exemplary matrix of pins and pads, forming a powered hinge connection to a jamb/pad side leaf of a door hinge in accordance with exemplary aspects of the present disclosure;

FIG. 3A is a side schematic view of an exemplary multiple pin to pad arrangement, showing the benefit of such a design holding a current path during stress and flexing of the components in accordance with exemplary aspects of the present disclosure;

FIG. 3B is a side schematic view of an exemplary separated positive and negative terminal embodiment in accordance with exemplary aspects of the present disclosure;

FIG. 3C is a side schematic view of an exemplary separated positive and negative terminal embodiment in accordance with exemplary aspects of the present disclosure;

FIG. 4A is a perspective view of an exemplary ribbon cable and PCBA components configured for use in a powered hinge in accordance with exemplary aspects of the present disclosure;

FIG. 4B is another perspective view of an exemplary ribbon cable and PCBA components configured for use in a powered hinge in accordance with exemplary aspects of the present disclosure;

FIG. 5A is a top plan view of a conventional hinge roll direction in accordance with exemplary aspects of the present disclosure;

FIG. 5B is a top play view of a reverse roll hinge configured to accommodate a flexible ribbon cable coil in accordance with exemplary aspects of the present disclosure;

FIG. 6A is a front elevation view of a contracted ribbon cable in accordance with exemplary aspects of the present disclosure;

FIG. 6B is a front elevation view of an extended ribbon cable in accordance with exemplary aspects of the present disclosure;

FIG. 6C is a front elevation view of a flat, rolled out design for the ribbon cable in accordance with exemplary aspects of the present disclosure;

FIG. 7A is a plan view of an exemplary powered hinge in accordance with exemplary aspects of the present disclosure; and

FIG. 7B is a perspective view of an exemplary powered hinge in accordance with exemplary aspects of the present disclosure.

### DETAILED DESCRIPTION OF EXEMPLARY EMBODIMENTS

Reference will now be made in detail to the exemplary embodiments and exemplary methods as illustrated in the accompanying drawings, in which like reference characters designate like or corresponding parts throughout the drawings. It should be noted, however, that the invention in its broader aspects is not necessarily limited to the specific details, representative materials and methods, and illustrative examples shown and described in connection with the exemplary embodiments and exemplary methods.

This description of exemplary embodiments is intended to be read in connection with the accompanying drawings, which are to be considered part of the entire written description. In the description, relative terms such as “horizontal,” “vertical,” “front,” “rear,” “upper”, “lower”, “top” and “bottom” as well as derivatives thereof (e.g., “horizontally,” “vertically,” “downwardly,” “upwardly,” etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. Additionally, the word “a” and “an” as used in the claims means “at least one” and the word “two” as used in the claims means “at least two”.

As we have noted, the present disclosure describes a modular powered door hinge. In exemplary aspects, the powered hinge has a power plate with an array of protruding pins (such as pogo pins), complementing a powered hinge having an array of conductive pads. Alternatively, an exemplary aspect includes a power plate with an array of conductive pads and a powered hinge plate having an array of protruding pins. In an example, the modular door hinge is configured to couple the array of protruded pins with the array of pads, to form an electrical connection between the power plate and the powered hinge. In an example, the array of protruded pins and the array of pads may be (e.g., magnetically) coupled with each other to form an electrical connection. Therefore, it may be easier for an operator to install even complex electronic architecture between the jamb and the door.

In exemplary embodiments, the power plate is a separate component and may be coupled to the jamb of the door. Based on the coupling of the power plate in the jamb of the door, the powered hinge may be coupled to the power plate. In exemplary embodiments, each pad of the array of pads may have different dimensions based on user requirements. For example, a few pads of the array of pads may have an increased diameter than a standard diameter, which eventually includes an increased surface area, to allow a tolerance between such pads and corresponding pins of the array of pins. Therefore, it may be easier for the operator to align the electronic components of the jamb with electronic components of the door.

In exemplary embodiments, the powered hinge comprises a pad side leaf and an interface side leaf, wherein the pad side leaf has the array of pads that are configured to couple with the power plate, with the interface side leaf including a status indicator (such as an LED light). The indicator may be configured to activate based on the electrical connection between all pins of the array of protruded pins and all pads of the array of pads, to ensure all contacts has been made. The indicator may also indicate various signals (such as, a yellow color indicating installation in progress, a green color indicating successful installation, and a red color indicating an abnormality in the installation). The indicator may be configured to be activated based on the electrical connection between the array of protruded pins and the array of pads. Therefore, based on the activation of the indicator, the operator may easily understand that the electrical components between the array of pads and the array of protruded pins are electrically connected or not. Such indicator light may also be hidden when the door is in a closed position.

The interface side leaf may also include at least one push button switch for an operator to interact with door electronics and perform operations associated with the door. Examples of the operations may include resetting the electronics of the door, or prompting a Bluetooth chip to broadcast so that an end-user can connect to the door via a mobile device (such as, a smartphone).

In exemplary embodiments, the overall system design allows a spacer element or cover to be used to provide a non-powered hinge by covering up the power connection on the jamb (the jamb connector or the power plate) when a powered hinge is not desired, but also allowing for an easy replacement with the powered hinge when installing a smart door. In such a case, an operator can merely remove the spacer/cover of the array of pads and/or the array of protruding pins to modularly upgrade the non-powered hinge to a powered hinge.

In further exemplary embodiments, there may be a push switch in the modular door hinge (in exemplary embodiments also hidden when the door is in a closed position) that performs an operation such as, resetting the modular door hinge, connecting the door to a cloud or a mobile device (such as a smartphone), troubleshooting the modular door hinge, etc.

The modular door hinge may also include other electronics (such as, PCBs, sensors, switches, etc.). Based on a validation of successful electrical connection of all pins of the array of protruded pins and all pads of the array of pads, via the indicator of the interface side leaf of the powered hinge, the interface side leaf is configured to couple with a door.

In further exemplary embodiments, power is provided through the hinge via a ribbon cable or via a flex printed circuit board (PCBA) with a cable component provided or coiled in the hinge itself. Such an embodiment can provide a more cost-effective solution by eliminating difficult machining and allow use of flexible PCBAs. Such a solution can also increase the number of electrical contacts available for the powered hinge. In exemplary aspects, a secondary molded piece can be used with the hinge to protect a ribbon cable and to house the connector or PCBA.

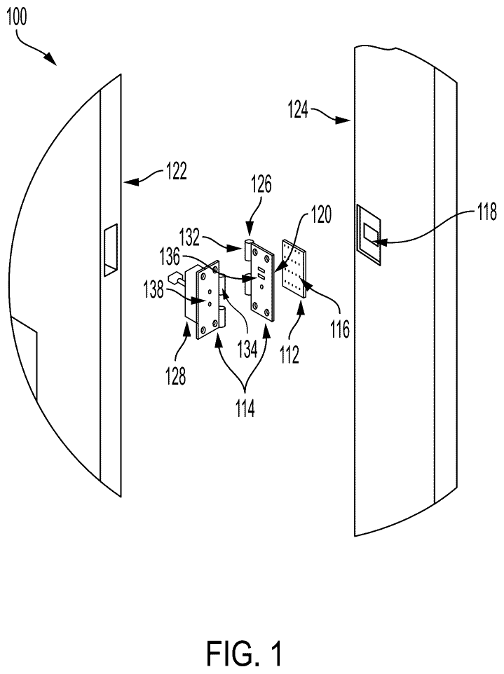

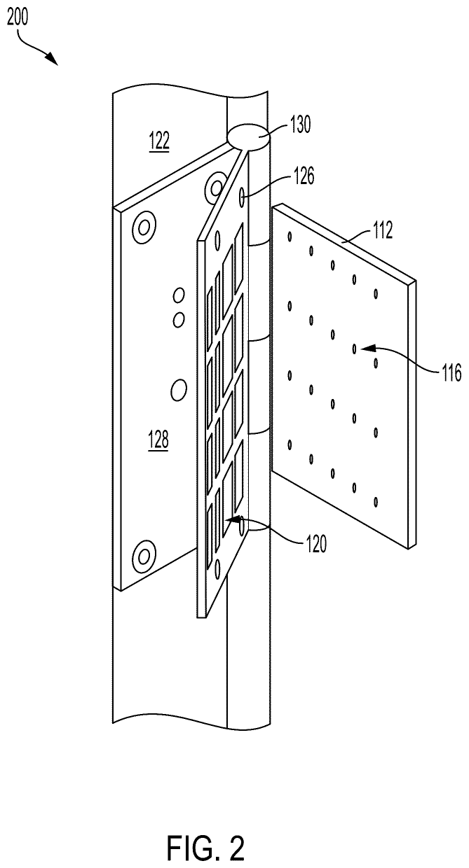

FIGS. 1 and 2 are diagrams depicting isometric views of an exemplary modular door hinge, shown generally at 100 and 200, respectively. The modular door hinge includes a power plate 112 and a powered hinge 114. The power plate 112 has an array of protruded pins 116 and is coupled to a door jamb via connector 118 or via direct wiring. The powered hinge 112 has an array of pads 120 and is disposed between a door slab 122 and the door jamb 124. In an embodiment, the modular door hinge is configured to couple the array of protruded pins with the array of pads, to form an electrical connection.

The exemplary door jamb includes a design, shape, and structure that is configured to form a lining of a doorway of a building. The door jamb, in the case of an exemplary rectangular door (though other shapes are contemplated herein), includes at least two vertical members (one of which is shown at 124) parallelly disposed with each other and a horizontal member (not shown) disposed at a top portion of the door. The door may also include a bottom portion that includes a sill (not shown). In case of interior doors, the door may not have the sill. The door jamb may also include a substantially square boundary, a substantially polygonal boundary, or indeed any desired shape. In certain instances, the door jamb may be a single rabbet door jamb, which may be configured to hold a single door. In other instances, the door jamb may be a double rabbet door jamb, which may be configured to hold at least two doors. Based on user requirements, the door jamb may be selectively modified to accommodate corresponding number of doors. In an embodiment, the modular door hinge may be coupled to the power plate that is connected with the jamb, via a jamb connector. In an alternate embodiment, the modular door hinge 100 may be coupled to the power plate 112 that is connected with the jamb 124, via a direct wiring connection.

An exemplary jamb connector 118 may include any desired design, shape, and structure, which may be disposed on the door jamb. In an exemplary embodiment, the jamb connector 118 is positioned at a midpoint of a section (such as, a vertical member) of the door jamb 124. In another embodiment, the jamb connector 118 may be positioned based on a user preference. For example, the jamb connector may be disposed proximate to a ground of the door jamb; or the jamb connector may be disposed proximate to a roof of the door jamb, based on a design of the door slab. In an embodiment, the jamb connector may be formed as a substantially rectangular profile. In other embodiments, the jamb connector may also be formed as a substantially square profile or a substantially circular profile, based on the design of the modular door hinge that connects the door slab with the door jamb. In an embodiment, the modular door hinge is coupled to the power plate that is magnetically coupled with the jamb connector. In an alternate embodiment, the modular door hinge is coupled to the power plate that is mechanically fastened with the jamb connector.

The power plate 112 may include a suitable design, shape, and structure, which may be configured to modularly couple with the jamb connector. In an embodiment, the power plate has a first surface and a second surface. The first surface (not shown, though on the back side of the surface shown at 116) may be coupled with the jamb connector 118 via a suitable coupling implement or directly wired to a power source. For example, the power plate may include a magnetic member (not shown) that may be coupled to the door jamb. In another example, the power plate may include a mechanical screw (not shown) that may be coupled to the door jamb. Further, the power plate 112 may include a plurality of electrical connections (not shown), which may be formed via wired/wireless connections between the power plate and the jamb connector. The second surface (see the exposed surface at 112/116) of the power plate 112 may include the array of protruded pins, which may be configured to couple with the powered hinge. In an embodiment, the power plate may be formed as a substantially rectangular profile. In another embodiment, the power plate may also be formed as a substantially square profile or a substantially circular profile, or any other desired profile shape, based on the design of the jamb connector.

In certain instances, the power plate 112 may be coupled with the jamb connector 118 via an interference fit. For example, the power plate may have a dimension which may be less than a dimension of the jamb connector, so that, the power plate may be fit within the jamb connector and flushed with the door jamb. In another example, the power plate may have a dimension which may be larger than a dimension of the jamb connector, so that, the jamb connector may be fit within the power plate and forms a flushed configuration. In yet another example, the power plate may be coupled with the jamb connector, such that, a part of the power plate may be protruded from a surface of the door jamb. In yet another example, the power plate may be coupled with the jamb connector, such that a part of the power plate and a part of the jamb connector protrude from a surface of the door jamb.

In some instances, the operator may not require any electrical connection for a certain period. In such instances, the operator may cover/conceal the jamb connector and/or the power plate with a spacer element or a cover (not shown), so that a non-powered hinge can be installed over the power plate, as a normal hinge. Therefore, in case of any modification of such normal hinge to powered hinge after certain period, the operator may modularly upgrade the normal hinge with a powered hinge, by merely removing the spacer/cover of the array of pads and/or the array of protruded pins. Such process may take a minimal amount of time for the operator.

In exemplary embodiments, the array of protruded pins may include any desired design, shape, and structure, which may be configured to electrically couple the power plate with the powered hinge. For example, the array of protruded pins may have a plurality of rows and a plurality of columns (such as a matrix). Each pin in the plurality of rows and each pin in the plurality of columns may be spatially arranged in the array of protruded pins to form a suitable structure, such as, a substantially rectangular array, a substantially triangular array, or a substantially polygonal array. Based on the spatial arrangement of the array of protruded pins, the operator may couple each pin of the array of protruded pins with corresponding pad of the array of pads located in the powered hinge. In an example, the array of protruded pins may be formed as/with pogo pins (though other connection configurations are contemplated herein, e.g., spring connections, terminals, etc.). In another example, the array of protruded pins may be formed as plurality cylindrical members that may be protruded from a base of the power plate. In yet another example, the array of protruded pins may be formed as plurality spherical/conical/frusto-conical/polygonal members that may be protruded from a base of the power plate.

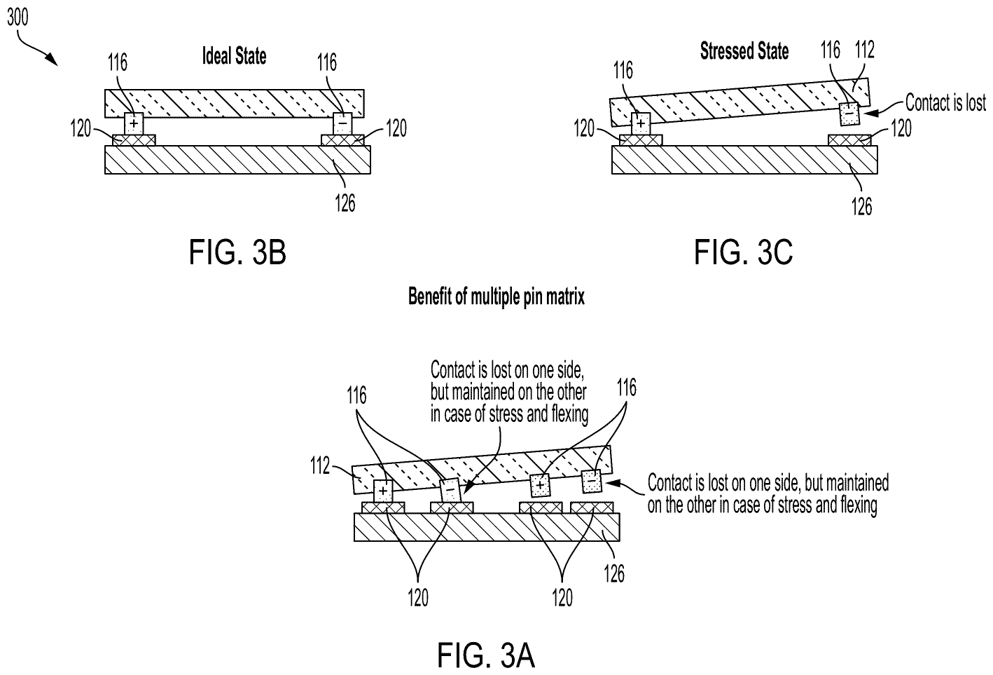

In an exemplary embodiment, each pin of the array of protruded pins may have a specific functional utility. For example, a first pin of the array of protruded pins may be formed as a positive terminal and a second pin of the array of protruded pins may be formed as a negative terminal. In some instances, there may be a third pin (and indeed many pins) in the array of protruded pins that may be used for power and/or data transmission between the door jamb and the door slab. In other examples, the structural arrangement of the array of protruded pins may also facilitate a strategic placement of multiple power and ground contacts that may allow the modular door hinge to be in contact under stressful situations, where the power plate and the powered hinge may be skewed/flexed in one direction or another. Description of such skewed configuration is further described, for example, in FIG. 3 (shown below). Based on the number of pins in the array of protruded pins, the operator may couple the power plate with the powered hinge, via a suitable coupling implement. In an example, the power plate is coupled to the powered hinge via a magnetic member. In another example, the power plate may be coupled to the powered hinge via a mechanical member, such as a fastener, a latch, and the like. In another exemplary embodiment, based on the array of protruded pins, the second surface of the power plate may also be coupled to the powered hinge.

The powered hinge may include any desired design, shape, and structure, which may be configured to couple the door jamb and the door slab, via the power plate. The powered hinge may include the pad side leaf 126 that may be coupled to the power plate 112 and may include the interface side leaf 128 that may be coupled to the door slab 122. In an exemplary embodiment, the pad side leaf and the interface side leaf may be coupled with each other, via a pivoted member 130, to form the powered hinge as a wing-like structure. The pivoted member may be a cylindrical member that may be integrally formed on edges of the pad side leaf and the interface side leaf, such that, a first cylindrical member 132 associated with the pad side leaf may be coupled with a second cylindrical member 134 associated with the interface side leaf, to form the pivoted member. In another example, instead of cylindrical members, there may be square members that may be integrally coupled with the pad side leaf and the interface side leaf, to form the pivoted member. In yet another example, instead of cylindrical members, there may be polygonal members that may be integrally coupled with the pad side leaf and the interface side leaf, to form the pivoted member. In yet another example, the pad side leaf and the interface side leaf may be coupled together, via a plurality of mechanical fasteners, such as, bolts, rivets, and the like. In an embodiment, the array of protruded pins of the power plate may be coupled to the pad side leaf, to form the electrical connection.

The exemplary pad side leaf may include any desired design, shape, and structure, which may be configured to couple with the power plate. In an embodiment, the pad side leaf may have a first surface and a second surface. The first surface may include the array of pads 120 (as shown in FIG. 2). Each pad of the array of pads is configured to couple with each pin of the array of protruded pins 116 of the power plate 112. In exemplary embodiments, at least two pads (or plural pads up to each pad) of the array of pads may have a different dimension based on user requirements. For example, a few pads of the array of pads may have an increased diameter than a standard diameter, which eventually includes an increased surface area, to allow a tolerance between such pads and corresponding pins of the array of pins. In such embodiments, it is easier for the operator to align the electronic components of the door jamb with electronic components of the door slab.

In further exemplary embodiments, the pad side leaf 126 may be coupled with the power plate 112, via magnetic member. In another example, the pad side leaf may be coupled with the power plate, via a mechanical member, such as, a fastener, a latch, and the like. Further, the pad side leaf may be formed as a substantially rectangular profile. In another embodiment, the pad side leaf may also be formed as a substantially square profile or a substantially circular profile, based on the design of the power plate.

The exemplary array of pads 120 may include any desired design, shape, and structure, which may be configured to couple the powered hinge with the power plate. For example, the array of pads 120 may have a plurality of rows and a plurality of columns. In exemplary embodiments, each pad in the plurality of rows and each pad in the plurality of columns may be spatially arranged in the array of pads to form a specific structure, such as, a substantially rectangular array, a substantially triangular array, or a substantially polygonal array. Based on the spatial arrangement of the array of pads, the operator may couple each pad of the array of pads with corresponding pin of the array of protruded pins located in the power plate.

In a further example, the array of pads 120 may be formed as tiles. In another example, the array of pads may be formed as plurality cut-outs that may be formed in the first surface of the pad side leaf of the powered hinge. In yet another example, the array of pads 120 may be formed as plurality recessed, corrugated, or wavy members that may be formed in the first surface of the pad side leaf of the powered hinge, to suitably align/mate with corresponding pin of the array of protruded pins disposed on the power plate.

In another exemplary embodiment, one or more pads (or plural pads up to each pad) of the array of pads 120 may have a specific functional utility. For example, a first pad of the array of pads 120 may be form a positive (+) terminal with the first pin of the array of protruded pins 116 of the power plate. In another example, a second pad of the array of pads 120 may form a negative (−) terminal with the second pin of the array of protruded pins 116 of the power plate. In some instances, there may be a third pad in the array of pads 120 that may be used for data transmission between the door jamb and the door slab, via the third pin of the array of protruded pins 116 of the power plate 112.

In further exemplary embodiments, the structural arrangement of the array of pads 120 also facilitates a strategic placement of multiple power and ground contacts that may allow the modular door hinge to be in contact under stressful situations, where the power plate 112 and the powered hinge (e.g., translated through leaf 126) may be skewed/flexed in one direction or another. Description of such skewed configuration is further illustrated, for example, in FIG. 3A. While separated positive and negative terminals are contemplated herein (shown e.g., in FIGS. 3B and 3C), the configuration of FIG. 3A does allow for flex across the pad leaf side 126 relative to the power plate 112, such that one or both of a contact pair (the positive (+) and negative (−) terminals) may lose contact with pads 120, with as illustrated, another contact pair of positive (+) and negative (−) terminals still providing a power pathway even in that stressed state that would otherwise disconnect power in the embodiment of FIG. 3C.

Based on the number of pads in the array of pads 120, the operator may couple the powered hinge with the power plate 112, via a suitable coupling implement. In an example, the array of pads 120 of the pad side leaf 126 of the powered hinge is coupled to the power plate 112, via magnetic member. In another example, the array of pads of the pad side leaf of the powered hinge is coupled to the power plate, via a mechanical member, such as, a fastener, a latch, and the like.

In an embodiment, the second side of the pad side leaf has an indicator 136 to provide a status of installation of the modular door hinge to the operator. In another embodiment, the interface side leaf has the indicator to provide the status of installation of the modular door hinge to the operator. In exemplary embodiments, the indicator 136 can be of any desired design, shape, and structure, which may be configured to may be configured to be activated based on the electrical connection between the array of protruded pins and the array of pads. For example, the indicator 136 may be a Light Emitting Diode (LED) that may indicate various signals (such as, a yellow color indicating installation in progress, a green color indicating successful installation, and a red color indicating an abnormality in the installation). Therefore, based on the activation of the indicator, the operator may easily understand that the electrical components between the array of pads and the array of protruded pins are electrically connected or not.

In another exemplary embodiment, the indicator 136 may be a speaker, which may output chimes or alert messages based on requirements of the user. For example, the indicator may be configured to output a notification based on a detection of one of: an abnormality in a wireless communication between the door slab and the door jamb, an abnormality in a wired communication between the door slab and the door jamb, a missed electrical connection between a specific pin of the array of pins and a specific pad of the array of pads, a low power of a battery associated with the modular door hinge, a charging status of a battery associated with the modular door hinge, a charged status of a battery associated with the modular door hinge, a maintenance/service notification after a certain period of installation of the modular door hinge, or other peripheral/general error states. In another example, the indicator may also be configured to display different colors and/or blink patterns to output the above-mentioned notifications. The indicator may be modularly disposed at any location of the powered hinge, for example, either in the pad side leaf, or in the interface side leaf, or a combination of both. In exemplary embodiments, the positioning of a visual indicator is internal to the hinge, and is configured to prevent bleed out of light while the door is in the closed state. Similarly, in embodiments where the indicator is a speaker, the closed state can serve to muffle or eliminate sound emitted therefrom.

In exemplary embodiments, the interface side leaf 128 can be of any desired design, shape, and structure, that is configured to pivotally couple with the pad side leaf 128, to form the powered hinge. In an embodiment, the interface side leaf 128 may have a coupling member that is configured to couple the interface side leaf with the door slab. For example, the interface side leaf may include a magnetic member that may be configured to couple the interface side leaf with the door slab. In another example, the interface side leaf may include other mechanical fasteners (such as, screws, rivets, etc.) that may be configured to couple the interface side leaf with the door slab. In an embodiment, the interface side leaf may include the indicator to output the status of installation to the operator.

In another exemplary embodiment, the interface side leaf may include a switch 138 to perform operations on the modular door hinge. The switch may include a suitable design, shape, and structure, which may be disposed on one of: either in the pad side leaf, or in the interface side leaf, or a combination of both, to control operations of the modular door hinge. In an exemplary embodiment, the operations of the switch may include, resetting the modular door hinge, connecting the hinge to a door, troubleshooting the modular door hinge, etc. In another exemplary embodiment, the switch may be configured to execute other custom operations, which may be set by the operator during installation of the modular door hinge. Examples of such custom operations may include, without limitation, one or more of: halting indicator signal when the operator is away; and locking a pivotal movement of the powered door hinge due for security purposes, etc.

In an exemplary embodiment, the modular door hinge also includes other electronics (such as, PCBs, processors, sensors, switches, etc.). In an exemplary embodiment, the sensors include magnetic reed switches that may be disposed between the pad side leaf and the interface side leaf of the powered hinge to detect opening and closing of the door slab from the door jamb via the powered door hinge. In other exemplary embodiments, the sensors may include a mechanical push switch that may be disposed between the pad side leaf and the interface side leaf of the powered hinge, to detect opening and closing of the door slab from the door jamb, via the powered door hinge. In yet another embodiment, the sensors may include a temperature sensor, which may be configured to detect at least one of: a temperature of a battery, an internal temperature, or an external temperature associated with the modular door hinge, and correspondingly control a charging rate of the battery. In yet another embodiment, the sensors may include a gyroscopic sensor, which may be configured to detect an angle of the door slab and correspondingly control the indicator to output the notification based on the angle of the door slab. For example, if the angle of the door slab with respect to the door jamb is 0 degrees, the modular door hinge may control the indicator to output the notification as “Door Closed”. In another example, if the angle of the door slab with respect to the door jamb is 30 degrees, the modular door hinge may control the indicator to output the notification as “Partially Open”. In yet another example, if the angle of the door slab with respect to the door jamb is more than 90 degrees, the modular door hinge may control the indicator to output the notification as “Completely Open”. In yet another example, if the angle of the door slab with respect to the door jamb is less than 30 degrees, the modular door hinge may control the indicator to output the notification as “Partially Closed”.

In yet another exemplary embodiment, the sensors may include a proximity sensor that may be configured to detect a proximity distance between the door slab and the door jamb. For example, if the proximity distance between the door slab and the door jamb is less than a standard proximity distance, the modular door hinge may control the indicator to output the notification as “Door Closed”. In another example, if the proximity distance between the door slab and the door jamb is greater than the standard proximity distance, the modular door hinge may control the indicator to output the notification as “Door Open”. Examples of the proximity sensor may include, a radio frequency (RF) sensor, a hall sensor, ultrasonic sensor, an optical sensor, a motion sensor, etc.

In operation, the modular door hinge is easily assembled between the door slab and the door jamb, based on the, e.g., magnetic coupling between each pin of the array of protruded pins of the power plate and each pad of the array of pads of the powered hinge, to form the electrical connection. Therefore, it may be easier for the operator to install even complex electronic architecture between the door slab and the door jamb.

Further, in embodiments where one or more pads of the array of pads have the increased diameter than the standard diameter, it may be further simplified for the operator to align each pin of the array of the protruded pins with corresponding pads with increased diameter, which eventually has the increased surface area of such pads, to allow a tolerance between such pads and corresponding pins of the array of pins.

During installation, in exemplary embodiments, if there is any abnormality in the installation, the indicator (which may be on either of the pad side leaf or the interface side leaf of the powered hinge), may output the notification for the operator, so that the operator can manually modify such abnormality in the installation of the modular door hinge and successfully install the modular door hinge between the door slab and the door jamb.

Further, in an exemplary operation, the modular door hinge is arranged in such a way that a contact between plural pins of the array of pins and plural pads of the array of pads can be permanently intact while the door slab is in one of: an open state, a closed state, or a transitioning state from the open state to the close state (or) from the close state to the open state (or possibly a stressed state).

In another exemplary embodiment, the modular door hinge includes a seal element that is configured to form a boundary for the modular door hinge, such that, the seal may protect pins and pads of the modular door hinge from one of: a mechanical impact, a chemical corrosion, or a fluid intrusion. The seal element may also prevent water ingress from getting to the electronics associated with the modular door hinge. The seal element may further prevent condensation (sweating) build up on the electronics associated with the modular door hinge.

As we have noted, FIG. 3A illustrates (generally at 300) an exemplary scenario that depicts an electrical connection between the power plate and the powered hinge in a stressed state, as does FIG. 3C. FIG. 3B illustrates an ideal state for the modular door hinge.

In the ideal state (FIG. 3B), for an operation of the door slab, there may be requirement for a permanent connection between each pin of the array of pins with each pad of the array of pads. In case of any abnormality in the electrical connection, there may be a malfunction in an opening and/or a closing of the door slab.

In the stressed state (FIG. 3C), though there may be two electric contacts, if there is a pressure on one edge of the powered hinge due to potential impact from an external environment, it may be noted that, there is a loose electrical connection between the negative terminal of the pin associated with such two electric contacts and corresponding negative terminal of the pad associated with such two electric contacts. Since, there is a chance of loose connection in such module, the installation may fail over time.

In an exemplary permanent connection state between the pad side leaf and the power plate (which state is contemplated herein), it may be observed that, irrespective of the pressure on one edge of the powered hinge due to potential impact from an external environment, it may be noted that, there is a permanent electrical connection between both positive and negative terminal of the pin associated with such multiple electric contacts and corresponding positive and negative terminal of the pad associated with such multiple electric contacts. Further, such configuration also enables a permanent connection for a data transfer, or any other operation. Therefore, such modular connection of the array of pins and the array of pads may improve electrical connection of the door slab compared to state-of-art technologies.

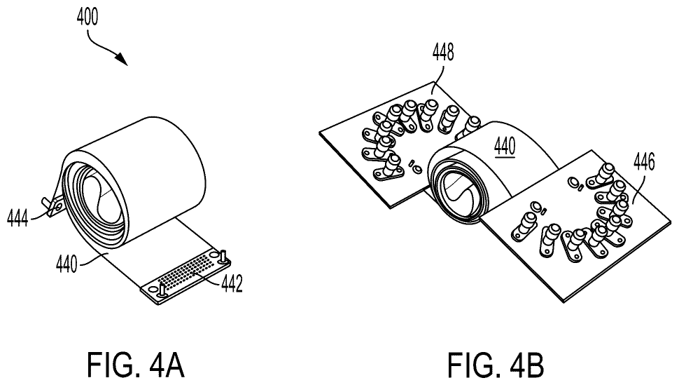

FIGS. 4A and 4B illustrate, generally at 400, exemplary ribbon cable and/or PCBA connections that may be used to transfer power between the pad side leaf 126 and the interface side leaf 128. FIG. 4A illustrates a ribbon cable 440 that can be used to transmit power and/or data through the hinge, with a first connector 442 connecting to the pad side leaf 126 and a second connector 444 connecting to the interface side leaf 128. FIG. 4B illustrates a ribbon cable 440 connected to a first PCBA 446 (the illustrated PCBA is representative) which may be attached to or associated with the pad side leaf 126 and a second PCBA 448, which may be attached to or associated with the interface side leaf 128. We note that any PCBA or other circuits or connectors may be flex circuits or connectors.

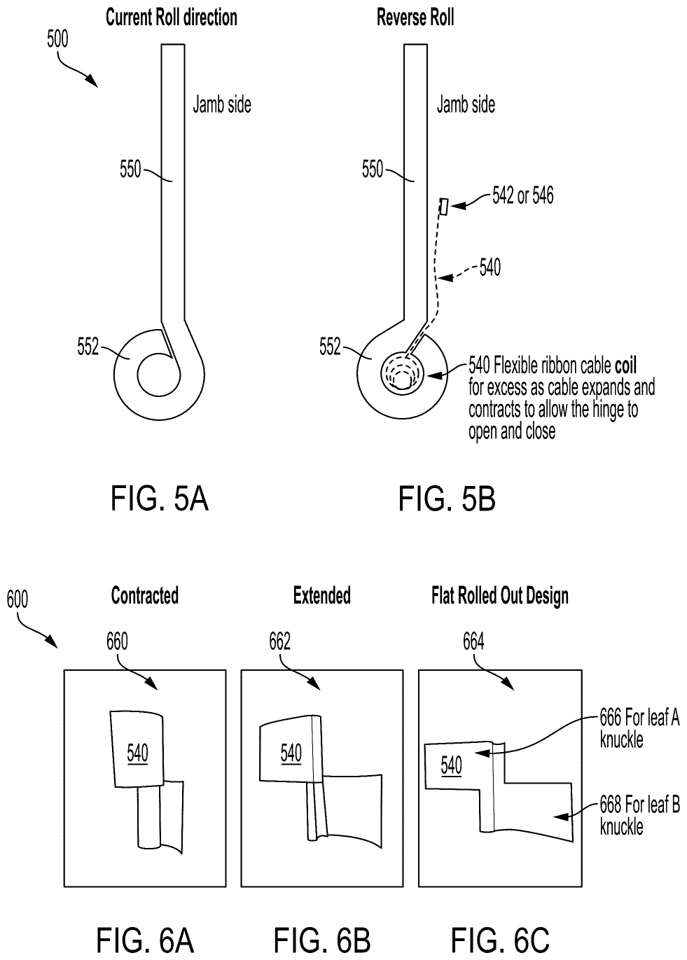

FIG. 5A illustrates generally at 500 a standard jamb side hinge plate 550 having a first, standard (clockwise) roll direction for the hinge portion 552. We note that the illustrated exemplary embodiment of FIG. 5B could be used with the standard roll direction hinge portion 552 if electrical connection is made through the hinge plate to the jamb side. FIG. 5B illustrates a reversed roll configuration (counterclockwise) for the hinge portion 552 of the jamb side hinge plate 550, avoiding the need to provide an electrical path through the plate 550 (since the ribbon cable connector 542 or PCBA 546 is already disposed on the jamb side of the plate 550), ready for connection of the cable or PCBA to the jamb itself or to an intermediate connector element. On that jamb side plate, the PCBA 542 or 546 is illustrated over that jamb side of plate 550, with the ribbon cable (noting that the cable need not specifically be a ribbon cable, but could be any electrical connective material or configuration) 540 on that jamb side and with excess ribbon cable coiled inside the hinge component 552 (which in exemplary aspects, such excess ribbon cable may be primed to coil back up when it is contracted to account for the opening and closing of the door and the variability of length needed or desired from the ribbon cable). Similarly the door side can be configured to provide the other end of the ribbon cable or PCBA on the door side of the hinge for connection to the door. In exemplary aspects, a normal hinge could also be modified to accommodate for a ribbon cable and/or powered hinge component, without difficult machining, specialty tools or waste.

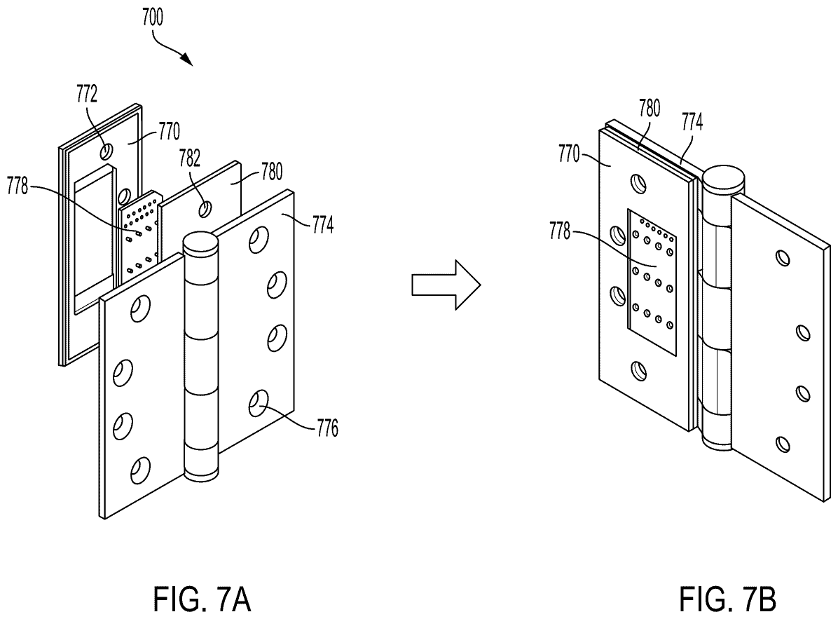

FIGS. 6A, 6B and 6C show three states generally at 600 for an exemplary ribbon) cable 558 (as in FIG. 5B, which as described above, may be any desired shape or size), with FIG. 6A showing a contracted state at 660, with FIG. 6B showing an extended state at 662 and with FIG. 6C showing a rolled out design 664. We note that for each of FIGS. 6A-C, the upper displayed portion is for a first leaf knuckle (Leaf A Knuckle 666); and the lower displayed portion is for a second leaf knuckle (Leaf B Knuckle 668). In exemplary embodiments, these leaf A and B knuckles are empty to allow for the ribbon cable 540 to freely coil. In further exemplary embodiments, one or more hinge pins only connects to one or more portions of the entire hinge assembly, leaving such empty space for the cable 540. With further reference to FIGS. 7A and 7B, an exemplary protection component for a ribbon cable or PCBA on the jamb side, as in FIG. 5B includes an open connection plate bracket 770 with mounting holes 772 corresponding to the hinge plate 774 mounting holes 776. An electrical connection layer 778 is provided between the bracket 770 and an insulating layer 780, which also includes mounting holes 782 corresponding to the hinge plate 774 mounting holes 776. In such a way, the electrical connection can be ‘hidden’ within the knuckle components and on the back sides of the hinge assembly.

Exemplary aspects of the present disclosure provide plural advantageous aspects. In exemplary embodiments with more than two electric contacts between the powered hinge and the power plate, in addition to positive and negative terminals for power transfer, there may also be a custom function (such as a data transfer) for other electric contacts between the powered hinge and the power plate. Further, in exemplary aspects, as the magnetic arrangement between the array of pins and the array of pads are modular, it may be easier for the operator to install even complex electronic architecture between the jamb and the door. Additionally, as few pads or all the pads of the array of pads may have the increased structural profile (such as diameter) than a standard profile, with increased tolerance between such pads and corresponding pins of the array of pins, it may be easier for the operator to align the electronic components of the jamb with electronic components of the door. Also, in exemplary aspects where there is an indicator in the powered hinge, based on the notification form the indicator, the operator may easily understand that the electrical components between the array of pads and the array of protruded pins are electrically connected or not, or other notifications associated with the door as described herein and, in exemplary embodiments, not experience light bleed or noise in a closed door position.

Also, in exemplary aspects, as the powered hinge and the power plate as a modular architecture, the power plate may be covered with a protection cover, dummy plate, spacer, etc., to conceal or to prevent contact between pins and pads; and a normal hinge may be coupled with or provided over the power plate. In case the user intends to upgrade to the powered hinge, the user may merely remove the protection cover and replace the normal hinge with the powered hinge and form the electrical connection between the powered hinge and the power plate.

Additionally, in exemplary aspects where the modular door hinge is arranged in such a way that a contact between each pin of the array of pins and each pad of the array of pads may be permanently intact (the door slab may never loose electric contact form the door jamb) while the door slab is in one of: an open state, a closed state, a transitioning state from the open state to the close state, from the close state to the open state, or in general over time as the door system may strain.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

1. A modular door hinge, comprising:
a jamb connector coupled to a door jamb;
a power plate coupled to the jamb connector, the power plate comprises an array of protruded pins; and
a powered hinge coupled between the power plate and a door slab, the powered hinge comprises an array of pads, wherein,
each pin of the array of protruded pins is configured to couple with each pad of the array of protruded pads.

2. The modular door hinge according to the claim 1, wherein each pin of the array of protruded pins is configured to form a permanent electrical connection with each pad of the array of protruded pads.

3. The modular door hinge according to the claim 1, wherein,
the array of protruded pins comprises at least two sets of pins disposed on opposing ends of the power plate,
the array of pads comprises at least two sets of pads disposed on opposing ends of the powered hinge, and wherein,
the at least two sets of pads are configured to mate with at least two sets of pins.

4. The modular door hinge according to the claim 1, wherein at least one pin of the array of protruded pins is configured to transfer data between the door slab and the door jamb.

5. The modular door hinge according to the claim 1, wherein the powered hinge further comprises a pad side leaf and an interface side leaf, the pad side leaf comprises the array of pads that are configured to couple with the power plate, and the interface side leaf comprises an indicator, which is configured to be activated based on an electrical connection between the array of protruded pins and the array of pads.

6. The modular door hinge according to the claim 5, wherein the indicator is configured to output a notification corresponding to an installation status of the electrical connection.

7. The modular door hinge according to the claim 1, further comprising a push switch, which is configured to control one of: a reset of the modular door hinge, a connection of the powered hinge to a door, or a troubleshoot of the modular hinge.

8. The modular door hinge according to the claim 1, wherein the powered hinge further comprises a pad side leaf and an interface side leaf, the pad side leaf comprises the array of pads that are configured to couple with the power plate, and the interface side leaf comprises an indicator, which is configured to be activated based on an electrical connection between all pins of the array of protruded pins and all pads of the array of pads.

9. The modular door hinge according to the claim 1, wherein the jamb connector is coupled to the door jamb.

10. The modular door hinge according to the claim 1, wherein the power plate is coupled to the jamb connector.

11. The modular door hinge according to the claim 1, wherein each pin of the array of protruded pins is configured to couple with each pad of the array of protruded pads.

12. The modular door hinge according to the claim 1, further comprising a seal to form a boundary for at least one of: the jamb connector, the power plate, or the powered hinge, to prevent an ingress of a fluid or a debris.

13. The modular door hinge according to the claim 1, wherein the array of pads has a substantially rectangular pattern, and wherein at least one pad of the array of pads has an increased dimension compared to a standard dimension.

14. The modular door hinge according to the claim 8, wherein the array of pins has a substantially rectangular pattern, with at least one interstitial spacing to accommodate the at least one pad of the array of pads with the increased dimension.

15. The modular door hinge according to the claim 1, wherein in a normal event, the array of pads is covered with a protection cover, to conceal the power plate and install a normal hinge to the power plate.

16. The modular door hinge according to the claim 15, wherein in an upgrade event, the normal hinge and the protection cover is removed from the power plate, and the powered hinge is installed to the power plate to form an electrical connection.

17. A powered door hinge, comprising:
at least two hinge leaves having interlocking knuckles, wherein at least one of knuckles for each leaf have a slotted opening to the jamb and door sides, respectively;
a ribbon cable provided through the slotted openings and into an open area of the knuckles, providing an electrical pathway from the back side of the jamb side leaf, through the open slot on the jamb side leaf knuckle, from within the open space in the jamb side leaf knuckle to the open space in the door side leaf knuckle and to the back side of the door side leaf.

18. A powered door hinge in accordance with claim 17, wherein the ribbon cable coils within the open spaces in the knuckle.

19. A powered door hinge in accordance with claim 17, wherein at least one end of the ribbon cable terminates with a printed circuit board.

20. A powered door hinge in accordance with claim 17, wherein the ribbon cable is connected to an electrical transfer layer that is housed between a protective cutout external layer and a hinge leaf insulating layer.
